(19) United States
(12) Patent Application Publication
(10) Pub. No.: US 2016/0351954 A1
(43) Pub. Date: Dec. 1, 2016

(54) SECONDARY BATTERY

(71) Applicant: SAMSUNG SDI CO., LTD., Yongin-si (KR)

(72) Inventors: Inhyun Lee, Yongin-si (KR); Minyoung Kim, Yongin-si (KR)

(21) Appl. No.: 14/957,505

(22) Filed: Dec. 2, 2015

(30) Foreign Application Priority Data
May 26, 2015 (KR) 10-2015-0072931

(51) Int. Cl. H01M 10/0564

(52) U.S. Cl. CPC H01M 10/0564; H01M 2300/0065

(57) ABSTRACT

A secondary battery includes an electrode assembly; a solid organic layer attached to at least one surface of the electrode assembly; a case having an opening and accommodating the electrode assembly, the solid organic layer, and an electrolyte; and a cap plate sealing the opening of the case.

### CROSS-REFERENCE TO RELATED APPLICATION

This application claims priority to and the benefit of Korean Patent Application No. 10-2015-0072931, filed on May 26, 2015 in the Korean Intellectual Property Office, the entire content of which is incorporated herein by reference.

### BACKGROUND

1. Field

Aspects of embodiments of the present invention relate to a secondary battery.

2. Description of the Related Art

In general, unlike a primary battery that is not rechargeable, a secondary battery can be repeatedly charged and discharged. Low capacity batteries that use single battery cells may be used as power sources for various portable small-sized electronic devices, such as cellular phones and camcorders. High power batteries that use tens of battery cells connected to each other in a battery pack may be used as power sources for hybrid vehicles or electric vehicles, for example.

Secondary batteries may be manufactured as different types, such as cylindrical and prismatic batteries. The secondary battery is generally configured by accommodating an electrode assembly having a positive electrode plate and a negative electrode plate and a separator as an insulator located therebetween in a case with an electrolyte, and installing a cap plate in the case. Here, positive and negative electrode terminals are connected to the electrode assembly and are exposed and protruded to the outside through the cap plate.

### SUMMARY

According to an aspect of embodiments of the present invention, a secondary battery can maintain an overall thickness by attaching a solid organic layer melted at a preset temperature or higher to an electrode assembly even if swelling occurs to the electrode assembly.

The above and other aspects of the present invention will be described in or be apparent from the following description of some exemplary embodiments of the present invention.

According to an aspect of one or more embodiments of the present invention, a secondary battery includes an electrode assembly; a solid organic layer attached to at least one surface of the electrode assembly; a case having an opening and accommodating the electrode assembly, the solid organic layer, and an electrolyte; and a cap plate sealing the opening of the case.

The solid organic layer and the electrolyte may include a same material.

The solid organic layer may include a mixture of an organic solvent and a lithium salt.

The solid organic layer may be melted at a reference temperature (e.g., a preset temperature) or higher to be mixed with the electrolyte.

The solid organic layer may include a case member and a solid organic material accommodated in the case member.

The case member may include at least one hole.

The solid organic material may be melted at a reference temperature (e.g., a preset temperature) or higher to be flowed to an outside of the case member.

The case member may include one selected from the group consisting of polyethylene, polypropylene, and a composite material of polyethylene and polypropylene.

The solid organic material and the electrolyte may include the same material.

As described above, the overall thickness of the secondary battery according to the present invention can be maintained by attaching a solid organic layer melted at a preset temperature or higher to an electrode assembly since the thickness of the solid organic layer is decreased even if the thickness of the electrode assembly is increased due to swelling occurring to the electrode assembly.

### BRIEF DESCRIPTION OF THE DRAWINGS

The above and other features and aspects of embodiments of the present invention will become more apparent by describing in further detail some exemplary embodiments thereof with reference to the attached drawings, in which:

FIG. 1 is a perspective view of a secondary battery according to an embodiment of the present invention;

FIG. 2 is an exploded perspective view of the secondary battery of FIG. 1;

FIG. 3 is a cross-sectional view of the secondary battery of FIG. 1, taken along the line I-I′;

FIGS. 4 and 5 are cross-sectional views of the secondary battery of FIG. 1, taken along the line II-II′, illustrating states before and after swelling occurs in the secondary battery, respectively;

FIG. 6 is a cross-sectional view of a solid organic layer of the secondary battery of FIG. 1; and

FIG. 7 is a cross-sectional view of a solid organic layer of a secondary battery, according to another embodiment of the present invention.

### DETAILED DESCRIPTION

Hereinafter, some exemplary embodiments of the present invention will be described in further detail with reference to the accompanying drawings. Various aspects of embodiments of the present invention may be embodied in many different forms and should not be construed as being limited to the example embodiments set forth herein. Rather, these example embodiments of the disclosure are provided so that this disclosure will be thorough and complete and will convey various aspects of the disclosure to those skilled in the art. As those skilled in the art would realize, the described embodiments may be modified in various different ways, all without departing from the spirit or scope of the present invention. Accordingly, the drawings and description are to be regarded as illustrative in nature and not restrictive.

In the drawings, the thicknesses of layers and/or regions may be exaggerated for clarity. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms “first,” “second,” etc. may be used herein to describe various members, elements, regions, layers and/or sections, these members, elements, regions, layers and/or sections should not be limited by these terms. These terms are only used to distinguish one member, element, region, layer and/or section from another. Thus, for example, a first member, a first element, a first region, a first layer and/or a first section discussed below could be termed a second member, a second element, a second region, a second layer and/or a second section without departing from the teachings of the present disclosure.

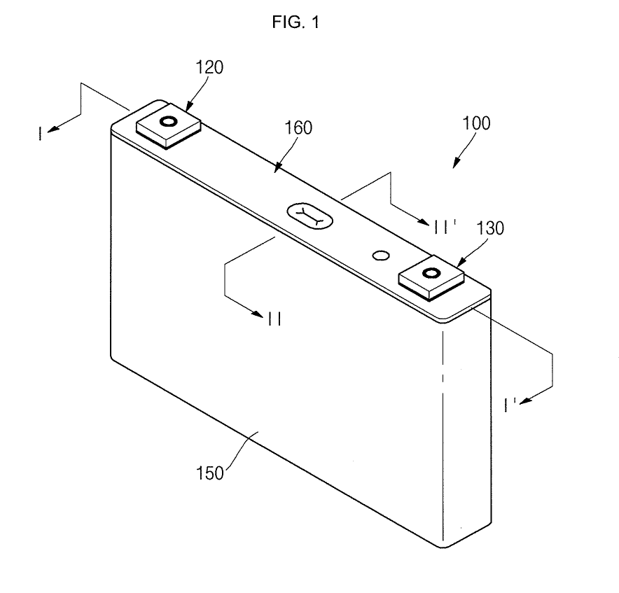

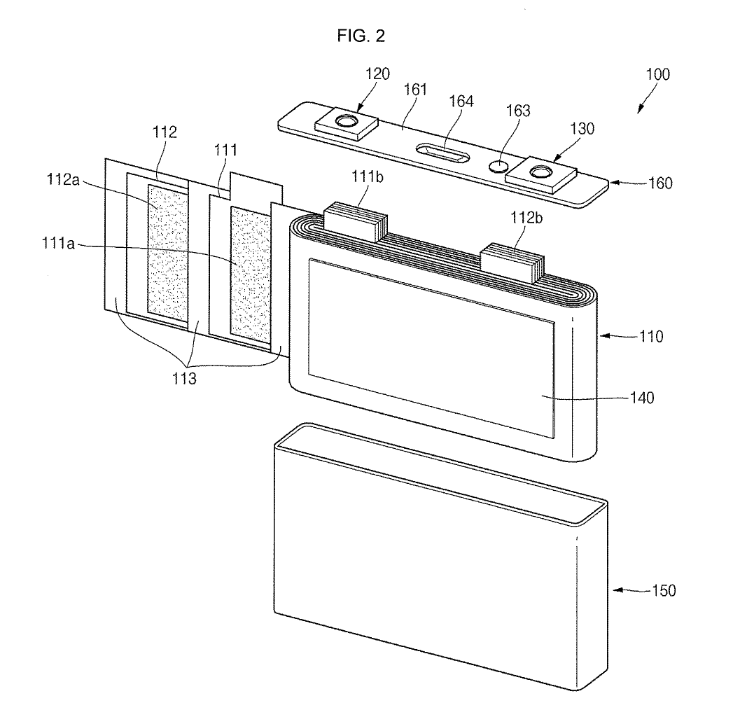

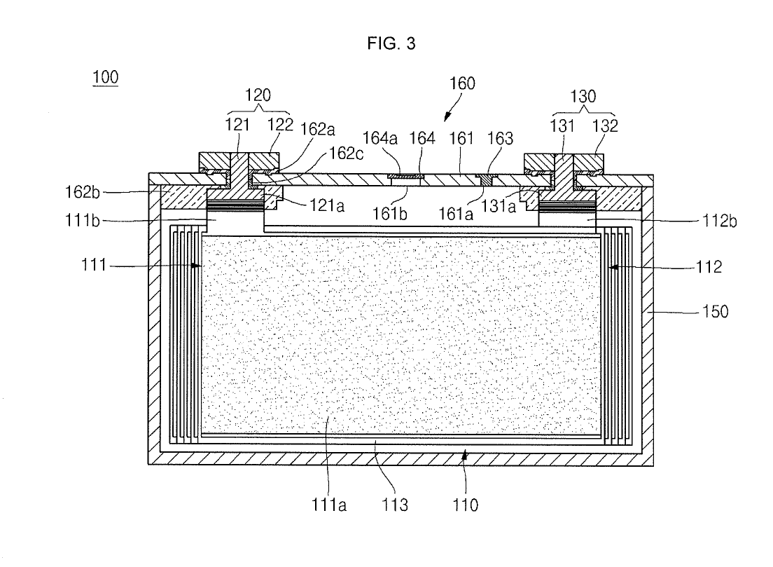

FIG. 1 is a perspective view of a secondary battery according to an embodiment of the present invention; FIG. 2 is an exploded perspective view of the secondary battery of FIG. 1; and FIG. 3 is a cross-sectional view of the secondary battery of FIG.1, taken along the line I-I′.

Referring to FIGS. 1 to 3, a secondary battery 100 according to an embodiment of the present invention includes an electrode assembly 110, a first terminal 120, a second terminal 130, a solid organic layer 140, a case 150, and a cap assembly 160.

The electrode assembly 110 may be formed by winding or laminating a stacked structure including a first electrode plate 111, a separator 113, and a second electrode plate 112, which are thin plates or layers. The first electrode plate 111 may function as a negative electrode and the second electrode plate 112 may function as a positive electrode, or vice versa.

The first electrode plate 111 may be formed by coating a first electrode active material made of graphite or carbon on a first electrode collector formed of a metal foil made of copper (Cu) or nickel (Ni). The first electrode plate 111 may include a first electrode active material layer 111a in which the first electrode active material is applied and a first electrode uncoated portion on which the first electrode active material is not applied. The first electrode uncoated portion may provide a passage for current flowing between the first electrode plate 111 and the outside of the first electrode plate 111. However, in embodiments of the present invention, the materials of the first electrode plate 111 are not limited to those disclosed herein.

The second electrode plate 112 may be formed by coating a second electrode active material made of, for example, a transition metal oxide, on a second electrode collector formed of a metal foil made of aluminum (Al) or an Al alloy. The second electrode plate 112 may include a second electrode active material layer 112a in which the second electrode active material is applied and a second electrode uncoated portion on which the second electrode active material is not applied. The second electrode uncoated portion may provide a passage for current flowing between the second electrode plate 112 and the outside of the second electrode plate 112. However, in embodiments of the present invention, the materials of the second electrode plate 112 are not limited to those disclosed herein.

In another embodiment, the first electrode plate 111 and the second electrode plate 112 having different polarities may be arranged.

The separator 113, positioned between the first electrode plate 111 and the second electrode plate 112, may inhibit a short circuit between the first electrode plate 111 and the second electrode plate 112 and may allow for movement of lithium ions. The separator 113 may be made of polyethylene, polypropylene, and/or a composite material of polyethylene and polypropylene. However, in embodiments of the present invention, the materials of the separator 113 are not limited to those disclosed herein.

The electrode assembly 110 may be accommodated in the case 150 with an electrolyte. The electrolyte may include a mixture of a lithium salt dissolved in an organic solvent. The electrolyte may be in a liquid, solid, or gel phase.

In more detail, usable examples of the organic solvent may include a carbonate-based solvent, an ester-based solvent, an ether-based solvent, a ketone-based solvent, an alcohol-based solvent, an aprotic solvent, and the like.

Examples of the carbonate-based solvent may include ethylene carbonate (EC), propylene carbonate (PC), butylene carbonate (BC), dimethyl carbonate (DMC), diethyl carbonate (DEC), dipropyl carbonate (DPC), methylpropyl carbonate (MPC), ethylpropyl carbonate (EPC), ethyl methyl acetate (EMC), and the like. Examples of the ester-based solvent may include methyl acetate, ethyl acetate, n-propyl acetate, dimethyl acetate, methyl propionate, ethyl propionate, γ-butyrolactone, decanolide, valerolactone, mevalonolactone, caprolactone, and the like. Examples of the ether-based solvent may include dibutyl ether, tetraglyme, diglyme, dimethoxyethane, 2-methyltetrahydrofuran, tetrahydrofuran, and the like. Examples of the ketone-based solvent may include cyclohexanone, and the like. Examples of the alcohol-based solvent may include ethyl alcohol, isopropyl alcohol, and the like. In addition, examples of the aprotic solvent may include nitriles, such as a nitrile of the formula R—CN (wherein R is a C₂-C₂₀ linear, branched, or cyclic hydrocarbon moiety that may include a double-bonded aromatic ring or an ether bond); amides, such as dimethylformamide; dioxolanes, such as 1,3-dioxolane; and sulfolanes. The organic solvent may be used either alone or in a combination of one or more solvents.

The lithium salt is dissolved in the organic solvent and functions as a source of lithium ions in the battery. That is, the lithium salt allows a lithium secondary battery to operate and facilitates movement of lithium ions between positive and negative electrodes. Representative examples of the lithium salt may include a mixture of one or more selected from LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (wherein x and y are natural numbers), LiCl, Lil, and LiB(C₂O₄)₂(“LiBOB”; lithium bis(oxalato)borate).

A first electrode tab 111b and a second electrode tab 112b may be connected to at least one location of each of the first electrode plate 111 and the second electrode plate 112, respectively. In more detail, the first electrode tab 111b is interposed between the electrode assembly 110 and the first terminal 120, and the second electrode tab 112b is interposed between the electrode assembly 110 and the second terminal 130. As described herein, the first electrode tab 111b and the second electrode tab 112b may be collectively referred to as electrode tabs 111b and 112b.

In an exemplary embodiment, the first electrode tab 111b may be the first electrode uncoated portion of the first electrode plate 111 of the electrode assembly 110, on which the first electrode active material 111a is not applied, or a separate member connected to the first electrode uncoated portion. Similarly, in an exemplary embodiment, the second electrode tab 112b may be the second electrode uncoated portion of the second electrode plate 112 of the electrode assembly 110, on which the second electrode active material 112a is not applied, or a separate member connected to the second electrode uncoated portion.

The first electrode tab 111b may be formed by extending from a top end of the electrode assembly 110 to a bottom end of the first terminal 120 to be described further later. The second electrode tab 112b may be formed by extending from the top end of the electrode assembly 110 to a bottom end of the second terminal 130 to be described further later. In one embodiment, the first electrode tab 111b and the second electrode tab 112b are directly electrically connected or welded to the first terminal 120 and the second terminal 130, respectively.

In a high-capacity, high-output battery, since a plurality of electrode tabs 111b and 112b extend from the electrode assembly 110, a high output current can be obtained. In addition, since the electrode tabs 111b and 112b (the uncoated portions or separate members) of the electrode assembly 110 are directly electrically connected to the corresponding terminals 120 and 130, which may shorten electrical paths, an electrically connecting process between the electrode assembly 110 and each of the terminals 120 and 130 can be simplified and an internal resistance of the secondary battery 100 and the number of components can be reduced. In one embodiment, a winding axis of the electrode assembly 110 and terminal axes of the first and second terminals 120 and 130 may be formed to be substantially parallel to each other, thereby providing good electrolyte impregnating capability of the electrode assembly 110 during injection of the electrolyte and facilitating a quick operation of a safety vent by allowing internal gases to rapidly move to the safety vent during overcharge of the secondary battery 100.

The first terminal 120 is electrically connected to the first electrode plate 111 and, in one embodiment, includes a first terminal pillar 121 and a first terminal plate 122.

The first terminal pillar 121 upwardly protrudes and extends a length (e.g., a predetermined length) while passing through a cap plate 161 to be described later. The first terminal pillar 121 is electrically connected to the first electrode tab 111b under the cap plate 161. In one embodiment, the first terminal pillar 121 includes a flange 121a formed under the cap plate 161 to prevent or substantially prevent the first terminal pillar 121 from being dislodged from the cap plate 161. In one embodiment, the first electrode tab 111b is electrically connected (e.g., welded) to the flange 121a, and the first terminal pillar 121 is electrically insulated from the cap plate 161.

In one embodiment, the first terminal plate 122 includes a centrally formed hole (not shown), and the first terminal pillar 121 is coupled and welded to the first terminal plate 122 in the hole. That is, boundary areas of the upwardly exposed first terminal pillar 121 and the first terminal plate 122 are welded to each other. For example, laser beams may be applied to the boundary area of the upwardly exposed first terminal pillar 121 and the first terminal plate 122, such that the boundary areas are welded to each other by melting and cooling.

The second terminal 130 is electrically connected to the second electrode plate 112 and, in one embodiment, includes a second terminal pillar 131 and a second terminal plate 132.

The second terminal pillar 131 upwardly protrudes and extends a length (e.g., a predetermined length) while passing through the cap plate 161 to be described later. The second terminal pillar 131 is electrically connected to the second electrode tab 112b under the cap plate 161. In one embodiment, the second terminal pillar 131 includes a flange 131 a formed under the cap plate 161 to prevent or substantially prevent the second terminal pillar 131 from being dislodged from the cap plate 161. In one embodiment, the second electrode tab 112b is electrically connected (e.g., welded) to the flange 131a, and the second terminal pillar 131 is electrically insulated from the cap plate 161. Alternatively, the second terminal pillar 131 may be electrically connected to the cap plate 161.

In one embodiment, the second terminal plate 132 includes a hole (not shown), and the second terminal pillar 131 is coupled and welded to the second terminal plate 132 in the hole. That is, boundary areas of the upwardly exposed second terminal pillar 131 and the second terminal plate 132 are welded to each other. For example, laser beams may be applied to the boundary area of the upwardly exposed second terminal pillar 131 and the second terminal plate 132, such that the boundary areas are welded to each other by melting and cooling.

The solid organic layer 140 is attached to at least one of opposite surfaces of the electrode assembly 110. In more detail, the solid organic layer 140 is formed to cover a pair of long side surfaces each having a relatively large area, among side surfaces of the electrode assembly 110. Here, the solid organic layer 140 exists in a solid phase at room temperature and is melted at a preset temperature or higher. Therefore, even if deterioration or swelling occurs to the secondary battery 100 due to continuous use of the secondary battery 100, the solid organic layer 140 is melted by heat generated in the secondary battery 100 and the thickness of the solid organic layer 140 is gradually reduced, thereby maintaining the overall thickness of the secondary battery 100. The solid organic layer 140 will later be described in more detail.

The case 150 may be formed of a conductive metal, such as aluminum, an aluminum alloy or nickel-plated steel and may have a substantially hexagonal shape having an opening through which the electrode assembly 110, the first terminal 120, and the second terminal 130 are inserted and placed. In one embodiment, the case 150 includes two pairs of side portions spaced a distance (e.g., a predetermined distance) apart from and facing each other and a bottom portion formed at lower portions of the two pairs of side portions to be perpendicular to the two pairs of side portions. In one embodiment, the internal surface of the case 150 is insulated and is insulated from the electrode assembly 110, the first terminal 120, the second terminal 130, and the cap assembly 160.

The cap assembly 160 is coupled to the case 150. That is, the cap assembly 160 seals the opening of the case 150. In one embodiment, the cap assembly 160 includes the cap plate 161, a seal gasket 162c, a plug 163, a safety vent 164, an upper insulation member 162a, and a lower insulation member 162b.

The cap plate 161 seals the opening of the case 150 and, in one embodiment, is made of the same material as the case 150. For example, the cap plate 161 may be coupled to the case 150 by laser welding. As described above, since, in one embodiment, the cap plate 161 may have the same polarity as the second terminal 130, the cap plate 161 and the case 150 may also have the same polarity.

The seal gasket 162c is made of an insulating material and is positioned between each of the first terminal pillar 121 and the second terminal pillar 131 and the cap plate 161, thereby sealing portions between each of the first terminal pillar 121 and the second terminal pillar 131 and the cap plate 161. The seal gasket 162c may prevent or substantially prevent external moisture from penetrating into the secondary battery 100 or may prevent or substantially prevent the electrolyte accommodated in the secondary battery 100 from flowing out.

The plug 163 seals an electrolyte injection hole 161a of the cap plate 161. The safety vent 164 is installed in a vent hole 161b of the cap plate 161 and has a notch 164a configured to be opened at a certain pressure (e.g., a predefined pressure).

The upper insulation member 162a is formed between each of the first terminal pillar 121 and the second terminal pillar 131 and the cap plate 161. In addition, the upper insulation member 162a makes close contact with the cap plate 161. Further, the upper insulation member 162a may also make close contact with the seal gasket 162c. In one embodiment, the upper insulation member 162a insulates each of the first terminal pillar 121 and the second terminal pillar 131 from the cap plate 161.

The lower insulation member 162b is formed between each of the first electrode tab 111b and the second electrode tab 112b and the cap plate 161, thereby preventing or substantially preventing unnecessary electrical short circuits from occurring. That is, the lower insulation members 162b inhibit occurrence of an electrical short circuit between the first electrode tab 111b and the cap plate 161 and an electrical short circuit between the second electrode tab 112b and the cap plate 161.

In one embodiment, the cap plate 161 has the same polarity as the second terminal 130, and the seal gasket 162c between the second terminal 130 and the cap plate 161, the corresponding upper insulation member 162a, and the corresponding lower insulation member 162b may not be provided.

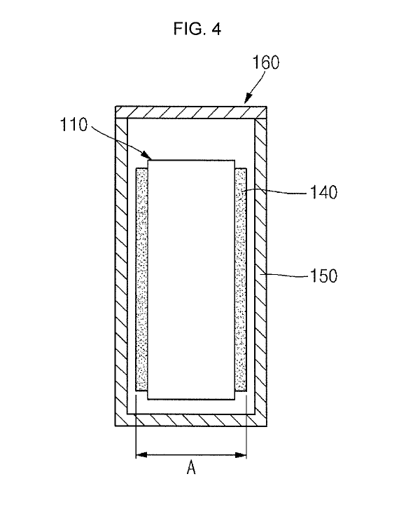

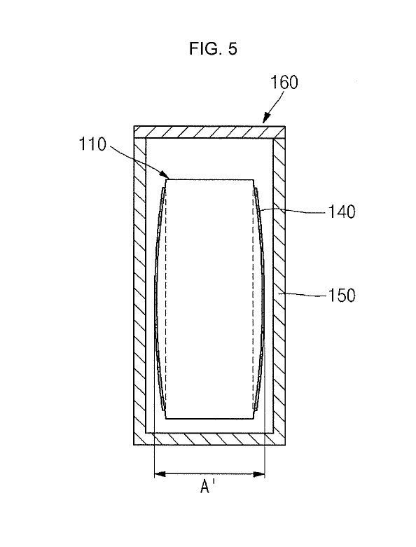

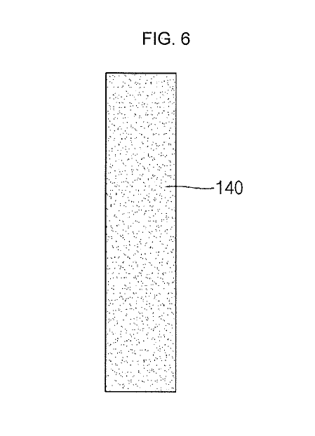

FIGS. 4 and 5 are cross-sectional views of the secondary battery of FIG. 1, taken along the line II-II′, illustrating states before and after swelling occurs to the secondary battery, respectively; and FIG. 6 is a cross-sectional view illustrating a solid organic layer of the secondary battery of FIG. 1.

Referring to FIGS. 4 to 6, the solid organic layer 140 is formed on at least one surface of the electrode assembly 110 of the secondary battery. The solid organic layer 140 may include a solid organic material, that is, a solid electrolyte. In one embodiment, the solid organic layer 140 is made of the same material as an electrolyte accommodated in the case 150 with the electrode assembly 110. In an exemplary embodiment, the solid organic layer 140 is formed of a mixture including a lithium salt dissolved in ethylene carbonate (EC) as an organic solvent. Here, the ethylene carbonate (EC) exists in a solid phase at room temperature and is melted at 40° C. or higher. Therefore, the solid organic layer 140 maintains its phase at room temperature. When the temperature of the secondary battery exceeds 40° C. due to heat generated in the secondary battery, the solid organic layer 140 may be melted to be mixed with the electrolyte. However, according to embodiments of the present invention, the materials and temperature of the solid organic layer 140 are not limited to those described herein. In other embodiments, the melting point of the solid organic layer 140 can be adjusted by changing the material of the organic solvent.

Due to continuous use, the secondary battery may deteriorate. In addition, the thickness of an electrode plate may be increased by organic materials generated by side reactions taking place at an interfacial surface between the electrolyte and the electrode plate, ultimately resulting in swelling of the secondary battery and increasing the overall thickness of the secondary battery. Here, the side reactions taking place at the interfacial surface between the electrolyte and the electrode plate may increase internal resistance, generating heat, and the solid organic layer 140 may be melted by the generated heat to have a gradually decreasing thickness. That is, according to the progress of deterioration and swelling of the secondary battery, the thickness of the electrode assembly 110 may be increased while the thickness of the solid organic layer 140 is gradually decreased, thereby maintaining the overall thickness of the secondary battery. Meanwhile, the melting of the solid organic layer 140 may not instantaneously occur but may occur slowly over a period of several months to several years.

In one or more embodiments of the present invention, a maximum thickness (A) of the electrode assembly 110 and the solid organic layer 140 before swelling occurs, as illustrated in FIG. 4, is substantially equal to a maximum thickness (A′) of the electrode assembly 110 and the solid organic layer 140 after swelling occurs, as illustrated in FIG. 5. Here, the electrode assembly 110 before swelling occurs is represented by a portion indicated by a dotted line of FIG. 5. In addition, while FIG. 5 illustrates that the thickness of the solid organic layer 140 is reduced, the solid organic layer 140 may be entirely melted and mixed with the electrolyte in the secondary battery.

As described above, the solid organic layer 140 is attached to the electrode assembly 110 and an initial thickness of the secondary battery is compensated for. In addition, even if the thickness of the electrode assembly 110 is increased with the progress of the deterioration of the secondary battery, the thickness of the solid organic layer 140 is gradually decreased, such that the overall thickness of the secondary battery may be maintained constant. Therefore, since a change in the external shape of the secondary battery is minimized or reduced, the performance, reliability, and stability of the secondary battery can be improved. In addition, since the solid organic layer 140 and the electrolyte may be made of the same material, the solid organic layer 140 may be stably mixed with the electrolyte in the secondary battery even if it is melted.

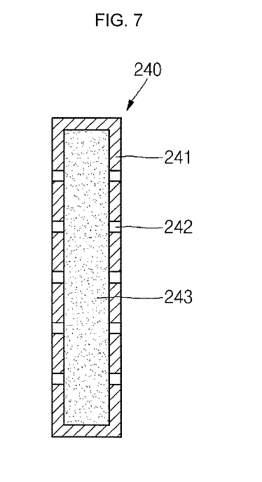

FIG. 7 is a cross-sectional view of a solid organic layer of a secondary battery, according to another embodiment of the present invention.

Referring to FIG. 7, a solid organic layer 240 of a secondary battery according to another embodiment of the present invention includes a case member 241 and a solid organic material 243 accommodated in the case member 241. That is, whereas the solid organic layer 140 of the previously described embodiment is composed of a solid organic material itself, e.g., a solid electrolyte, the solid organic layer 240 of the present embodiment includes the solid organic material 243 accommodated in the case member 241. Meanwhile, since the solid organic material 243 performs the same function as the solid organic layer 140 of the previously described embodiment, repeated descriptions thereof will be omitted.

The case member 241 may be made of polyethylene, polypropylene, and/or a composite material of polyethylene and polypropylene. In one embodiment, the case member 241 is made of an insulating material and may have improved stability even if it is brought into direct contact with the electrode assembly. In addition, the case member 241 includes a plurality of holes 242 formed on at least one surface of the case member 241. In an exemplary embodiment, the holes 242 are formed on a pair of wide side surfaces among side surfaces of the case member 241. Therefore, when the solid organic material 243 is melted at a preset temperature or higher, it may be flowed or exhausted to the outside of the case member 241 through the holes 242 to then be mixed with the electrolyte in the secondary battery. Here, even if the solid organic material 243 is entirely melted until it maintains no distinct shape, the case member 241 may remain intact outside the electrode assembly.

That is, in a secondary battery according to another embodiment of the present invention, the solid organic layer 240 includes the case member 241 and the solid organic material 243 accommodated in the case member 241. Since the case member 241 is made of an insulating material, it may have improved stability when it is brought into contact with the electrode assembly. In addition, the solid organic material 243 may be melted by the heat generated in the secondary battery to then be flowed or exhausted to the outside of the case member 241 through the holes 242. Therefore, even if the thickness of the electrode assembly is increased by deterioration and swelling, the thickness of the solid organic layer 240 is decreased by the melting of the solid organic material 243, thereby maintaining the overall thickness of the secondary battery. That is, since a change in the external shape of the secondary battery is minimized or reduced, the performance, reliability, and stability of the secondary battery can be improved.

While the present invention has been particularly shown and described with reference to some exemplary embodiments thereof, it will be understood by those of ordinary skill in the art that various changes in form and details may be made therein without departing from the spirit and scope of the present invention as defined by the following claims and equivalents thereof.

What is claimed is:

1. A secondary battery comprising:
an electrode assembly;
a solid organic layer attached to at least one surface of the electrode assembly;
a case having an opening and accommodating the electrode assembly, the solid organic layer, and an electrolyte; and
a cap plate sealing the opening of the case.

2. The secondary battery of claim 1, wherein the solid organic layer and the electrolyte comprise a same material.

3. The secondary battery of claim 1, wherein the solid organic layer comprises a mixture of an organic solvent and a lithium salt.

4. The secondary battery of claim 1, wherein the solid organic layer is melted at a reference temperature or higher to be mixed with the electrolyte.

5. The secondary battery of claim 1, wherein the solid organic layer comprises a case member and a solid organic material accommodated in the case member.

6. The secondary battery of claim 5, wherein the case member includes at least one hole.

7. The secondary battery of claim 5, wherein the solid organic material is melted at a reference temperature or higher to be flowed to an outside of the case member.

8. The secondary battery of claim 5, wherein the case member comprises one selected from the group consisting of polyethylene, polypropylene, and a composite material of polyethylene and polypropylene.

9. The secondary battery of claim 5, wherein the solid organic material and the electrolyte comprise a same material.
